(19) United States
(12) Patent Application Publication
(10) Pub. No.: US 2004/0141477 A1
(43) Pub. Date: Jul. 22, 2004

(54) Method, system and mobile host for mobility pattern based selection of a local mobility agent

(75) Inventors: Yi Xu, Singapore (SG); Chee Jwai Lee, Singapore (SG); Vrizlynn Ling Ling Thing, Singapore (SG)

Correspondence Address: Crockett & Crockett, Suite 400, 24012 Calle De La Plata, Laguna Hills, CA, 92653, US

(73) Assignee: Institute for Infocomm Research

(21) Appl. No.: 10/349,694

(22) Filed: Jan. 22, 2003

(51) Int. Cl. H04B 7/00

(52) U.S. Cl. 370/328

(57) ABSTRACT

A method of selecting a local mobility agent (LMA) from several LMAs in a visited domain, to serve as a local home agent, for registration with a home agent in a home domain of a mobile host is disclosed. The method includes determining a mobility pattern of the mobile host within the visited domain in a given time interval and selecting a LMA from the several LMAs at the end of the time interval depending on the mobility pattern of the mobile host. The selected LMA is registered with the home agent if the selected LMA is different from a LMA currently registered with the home agent. A system, subsystem and a mobile host that perform the above-described method are also disclosed.

### BACKGROUND

This invention relates to mobility management of a mobile host in a Mobile IP: network. More particularly, this invention relates to the selection of a local mobility agent (LMA) in a visited network or domain for registration with a home agent in a home network or domain, wherein the selection is based on a mobility pattern of a mobile host.

Mobile Internet users require special mobility support for their mobile nodes or hosts to maintain connectivity as they change their location or point-of-attachment in a system. This mobility support is being integrated into contemporary networks. With mobility support, regardless of where a mobile host resides physically in the system, the system is able to provide transparent support for communications with correspondent nodes on the network for Open Systems Interconnection (OSI) layers above the network layer. The Internet Engineering Task Force (IETF) Mobile IP protocol has been proposed to address the mobility issue in the network layer protocol, Internet Protocol (IP). With Mobile IP, each time a mobile host moves away from its home domain to a visited subnet, the mobile host is assigned a careof address (CoA) in the visited subnet. The mobile host registers this assigned CoA with a home agent in a home domain of the mobile host. With this registration, the CoA is associated with the mobile host's home address. Such an association is referred to as a binding and the registration as a binding update. The home agent records this binding as an entry in a binding cache. At this point, the home agent serves as a proxy for the mobile host until the mobile host's binding entry expires. Also at this point, correspondent nodes are not aware of the mobile host's new location and will continue to send packets to the mobile host's home address. The home agent on receiving these packets redirects or tunnels the packets to the mobile host's CoA. The mobile host may send a similar binding update to the correspondent nodes. If such binding updates are sent to the correspondent nodes, the correspondent nodes can subsequently send packets directly to the mobile host using the CoA.

Typically, a Local Mobility Agent (LMA) in a visited domain that is serving the mobile host assigns a single CoA for the mobile host. Only one registration with the home agent involving this single CoA is necessary. Subsequent movement of the mobile host within the visited domain will not result in further registrations with the home agent. Any packets for the mobile host sent to the home address will be redirected by the home agent to the LMA using the CoA. The CoA therefore remains unchanged and valid outside of the visited domain despite local mobility of the mobile host within the visited domain. Although such a scheme has the advantage of reducing registration traffic outside of the visited domain, it suffers a disadvantage. The serving LMA has the responsibility of tracking the movement of the mobile host within the visited domain and will therefore see a signaling and processing load associated with local registrations equivalent to the number of mobile hosts in the visited domain. Each time a mobile host changes a point-of-attachment within the visited domain, the LMA is informed through a local registration or binding update of its new point-of-attachment. If there are a large number of local registrations due to there being a large number of mobile hosts or frequent change of point-of-attachment of a number of the mobile hosts, the LMA may be swamped.

To reduce the processing load at a LMA, multiple LMAs organized in a hierarchical configuration in a visited domain can be used. One of the LMAs has to be selected for registration with a home agent. It is desirable to select a LMA that is a compromise between the need to limit the number of registrations with the home agent and the processing load demands associated with local registrations at a LMA.

### SUMMARY

According to an aspect of the present invention, there is provided a method of selecting a local mobility agent (LMA) from a plurality of LMAs in a visited domain, to serve as a local home agent, for registration with a home agent in a home domain of a mobile host that has moved into the visited domain. The method includes determining a mobility pattern of the mobile host within the visited domain and selecting a LMA from the plurality of LMAs depending on the mobility pattern of the mobile host for registration With the home agent.

According to another aspect of the present invention, there is provided a system for mobility management. The system includes a home domain that includes a home agent serving a mobile host. The system also includes a visited domain that has a means for determining a mobility pattern of the mobile host within the visited domain. The visited domain also includes a means for selecting a LMA from a plurality of LMAs in the visited domain depending on the mobility pattern for registration with the home agent.

According to yet another aspect of the present invention, there is provided a subsystem that serves as a visited domain and that includes the means described above.

According to a further aspect of the present invention, there is provided a mobile host that facilitates selection of a LMA for registration according to the method described above. The mobile host includes the above-described means.

### BRIEF DESCRIPTION OF DRAWINGS

The invention will be better understood with reference to the drawings, in which:

FIG. 1 is a schematic diagram of an exemplary system having domains in which an embodiment of the present invention may be implemented;

FIG. 2 is a schematic diagram of a system similar to that in FIG. 1 further showing a home agent in a home domain, a correspondent node in a correspondent domain and multiple LMAs in a visited domain, wherein the LMAs facilitates intra-domain mobility of a mobile host in the visited domain;

FIG. 3 is a schematic diagram similar to that in FIG. 2 showing paths from each access router to a gateway LMA of the visited domain;

FIG. 4 is a schematic diagram showing an advertisement message used in the system in FIG. 3 for automatically discovering the paths;

FIG. 5 is a flowchart of a sequence of steps, according to an embodiment of the present invention, for selecting a LMA amongst the multiple LMAs in FIG. 2 for registration with the home agent; and

FIG. 6 is a flowchart of a sequence of steps for processing the advertisement message of FIG. 4.

### DETAILED DESCRIPTION

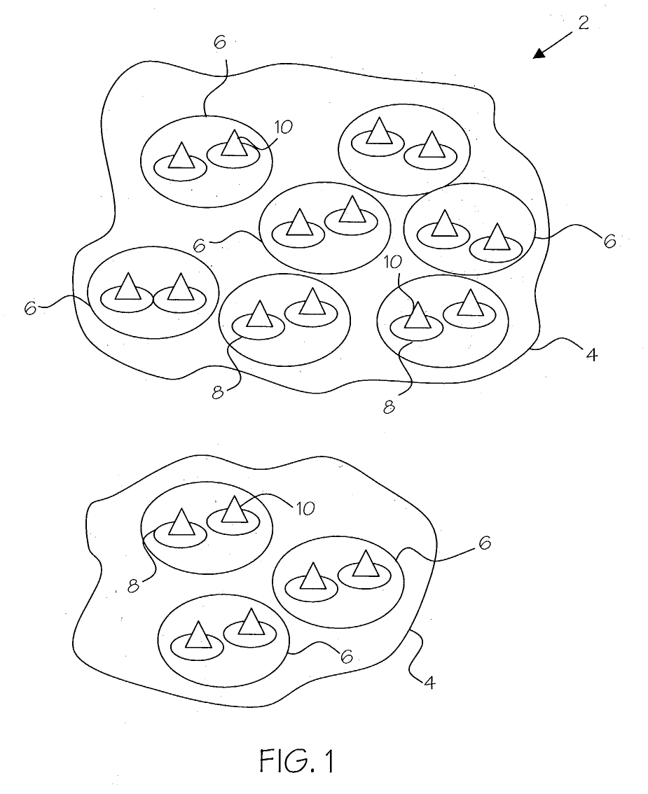

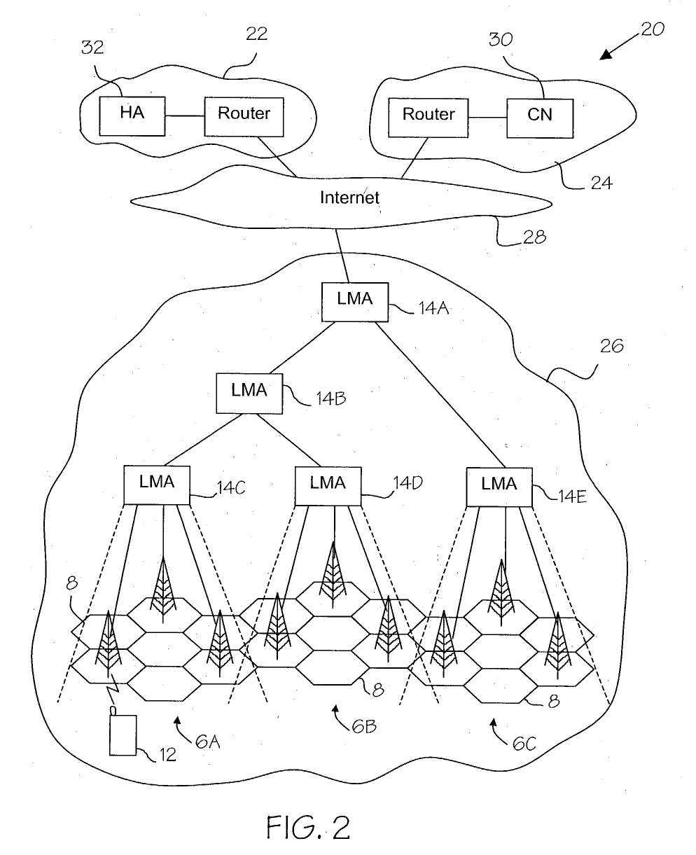

FIG. 1 illustrates an exemplary wireless system 2, in which an embodiment of the present invention may be implemented. As shown, the system 2 includes a number of networks or domains 4, each including a plurality of subnetworks or subnets 6. Each subnet 6 includes a plurality of cells 8 covered by respective base stations 10. A mobile host 12 (FIG. 2) may transition across a number of boundaries between cells 8 and subnets 6 to change its location or point-of-attachment in the system 2. A mobile host 12 is a wireless device such as a mobile phone, a digital personal assistant (PDA), a portable personal computer or the like. The mobile host 12 includes a data processing unit (not shown), such as a microprocessor.

The transition of a mobile host 12 from a cell 8 to another cell 8 within the same subnet 6 is managed using a data link layer (OSI layer-2) protocol. The transition of a mobile host 12 from one subnet 6 to another subnet 6 within the same domain 4 is referred to as intra-domain mobility. Finally, a mobile host 12 may also transition from one domain 4 to another domain 4. This movement is referred to as inter-domain mobility. Such subnet-crossing and domain-crossing mobility may be handled using layer-3 protocols, such as the Mobile IP, or using application layer protocols, such as Session Initiation Protocol (SIP) involving a SIP proxy (not shown).

FIG. 2 illustrates a system 20 for facilitating intra-domain mobility of a mobile host 12, in accordance with an embodiment of the present invention. The system 20 includes a home network or domain 22, a correspondent network or domain 24, and a foreign or visited network or domain 26, all connected via a network, such as the Internet 28. The home domain 22 may include a domain in which the mobile host 12 is given a longterm Internet Protocol (IP) address. The visited domain 26 may include any domain other than the mobile host's home domain 22. More specifically, if the home domain 22 includes more than one subnet, a visited domain 26 may include subnets other than the mobile host's home subnet. The correspondent domain 24 may include a correspondent node 30 with which the mobile host 12 communicates.

The home domain 22 includes a globally accessible redirection agent, home agent 32 or SIP proxy that maintains the current location information of the mobile host 12. This location information includes a global care-of-address (CoA). For example, the home agent 32 may include a table associating the home address of each mobile host 12 with a global CoA received for the mobile host 12. Using the global CoA, the home agent 32 may forward communications to a mobile host 12. The home address of the mobile node 12 remains unchanged, regardless of the mobile host's current location in the system 20. A communication with the mobile host 12 may include information in one or more packets.

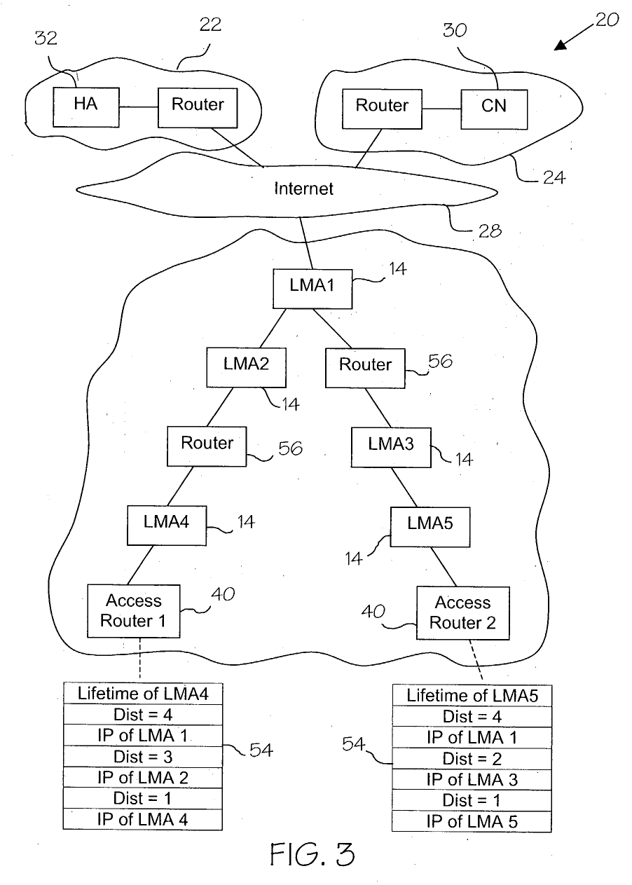

The correspondent domain 24 may include a correspondent node 30 with which the mobile host 12 may communicate. The correspondent node 30 may be either mobile or stationary. The visited domain 26 may include a number of subnets (groups of which are referenced in FIG. 2 as subnet groups 6A, 6B and 6C). The visited domain 26 also includes several access routers 40 (two of which are shown in FIG. 3 but not shown in FIG. 2 for simplicity) and several local mobility agents (LMAs) 14A-14E. Each of the access routers 40 is connected to the home agent 32 via a respective transmission path. One or more LMAs 14A-14E lie along each transmission path. One of the LMAs 14A-14E may provide a unique globally reachable global care-of-address (CoA) for the mobile host 12 and may intercept or receive packets forwarded to the mobile host 12 using the provided global CoA. The global CoA can be assigned using any method by an LMA 14A-14E as long as the LMA 14A-14E can act as a proxy for intercepting any packet sent using an assigned global CoA. One method is to provide each LMA 14A-14E with a pool of unique globally reachable global CoAs, for example, from an Internet Service Provider (ISP), for per mobile host 12 assignment. Another method is to assign to the mobile host 12 the IP address itself of an LMA 14A-14E for use as a global CoA. Such a method allows more than one mobile hosts 12 to share the same global CoA. The LMA 14A-14E whose IP address is used as the global CoA will then identify a particular mobile host for forwarding a packet using the mobile host home address carried in the packet.

According to an embodiment of the present invention, one of the LMAs 14A-14E is selected to serve as a local home agent for the mobile host 12 depending on the mobility pattern of the mobile host 12 between the subnet groups 6A-6C of the visited domain 26 during a given time interval. For example, if a mobile host 12 remains within a single subnet group 6A, 6B or 6C during the time interval, a respective LMA 14C-14E lower in a hierarchy of the LMAs 14A-14E will be selected to serve the mobile host 12. If the mobile host 12 moves between subnet group 6A and 6B during the time interval, the intermediate LMA 14B will be selected to serve the mobile host 12. If, however, the mobile host 12 moves between all subnet groups 6A-6C of the visited domain 26 during the time interval, the LMA 14A that is highest in the hierarchy will be selected to serve the mobile host 12. The LMA 14A is termed a gateway LMA since it also plays the role of a conventional domain gateway for connecting the other LMAs 14B-14E to the home agent 32. If there are more than one LMAs acting as conventional gateways simultaneously, one of them is configured to be the gateway LMA to initiate a LMA discovery process in the visited domain 26. The details of discovering LMAs 14A-14E and selecting which of the LMAs 14A-14E to serve a mobile host 12 will be described shortly. It should be noted that a LMA is a function that can be performed by any router 56 (FIG. 3) in the visited domain 26; the LMA does not need to reside on a machine that is separate from a router 56. The routers 56 in FIG. 3 that perform the function of a LMA are given a reference numeral 14.

Besides the global CoA assigned by a selected LMA 14A-14E, the mobile host 12 also obtains a local CoA from an access router 40 communicating therewith. The global CoA is used outside of the visited domain 26 for addressing the mobile host 12 while the local CoA is used within the visited domain 26. The use of such an addressing scheme allows routing outside of the visited domain 26 to be independent of the actual location of the mobile host 12 within the visited domain 26. However, any movement of the mobile host 12 across the subnet boundary will result in a local registration with the selected LMA to provide the LMA with a new local care-of-address of the mobile host 12. Hereinafter, provision of a global CoA by a selected LMA 14A-14E to the home agent 32 is referred to as a registration of the selected LMA 14A-14E with the home agent 32 for ease of description.

A method for periodically selecting a LMA from the LMAs 14A-14E in a visited domain 26 for a mobile host 12 for registration with the home agent 32 is next described. According to a generic embodiment, the method involves determining a mobility pattern of the mobile host 12 during a given time interval. A LMA 14A-14E is selected based on the mobility pattern. The selected LMA 14A-14E is registered with the home agent 32 if it is determined that the selected LMA 14A-14E is different from a LMA 14A-14E currently registered with the home agent 32.

Preferably, determining the mobility pattern of the mobile host 12 according to the generic embodiment involves determining at least one LMA 14A-14E along a transmission path of one or more access routers 40 that communicate with the mobile host during the time interval. In this case, a LMA 14A-14E common to the transmission paths of each of the one or more access routers 40 involved is selected for registration. Preferably, a common LMA 14A-14E whose distance is closest to the one or more access routers 40 is selected. The selected LMA 14A-14E can be registered with one or more correspondent nodes 30 that is communicating with the mobile host 12 if the selected LMA is registered with the home agent 32. Such registrations with the correspondent nodes 30 do not happen instantaneously but take some time to complete. During this time, packets sent by the correspondent nodes 30 to the previously registered LMA may be in transit. It is thus preferable in addition to registering the selected LMA with the correspondent nodes 30 to also register the selected LMA with the LMA previously registered with the home agent 32. By doing so, the previously registered LMA may redirect any in-transit packets destined for the mobile host 12 to the selected LMA. As it takes only a short duration, approximately equal to the round trip transmission delay of a packet from the mobile host 12 to a correspondent node 30, for completion of registration of the selected LMA with the correspondent nodes 30, the registration with the previously registered LMA may last only temporarily, such as for a few seconds.

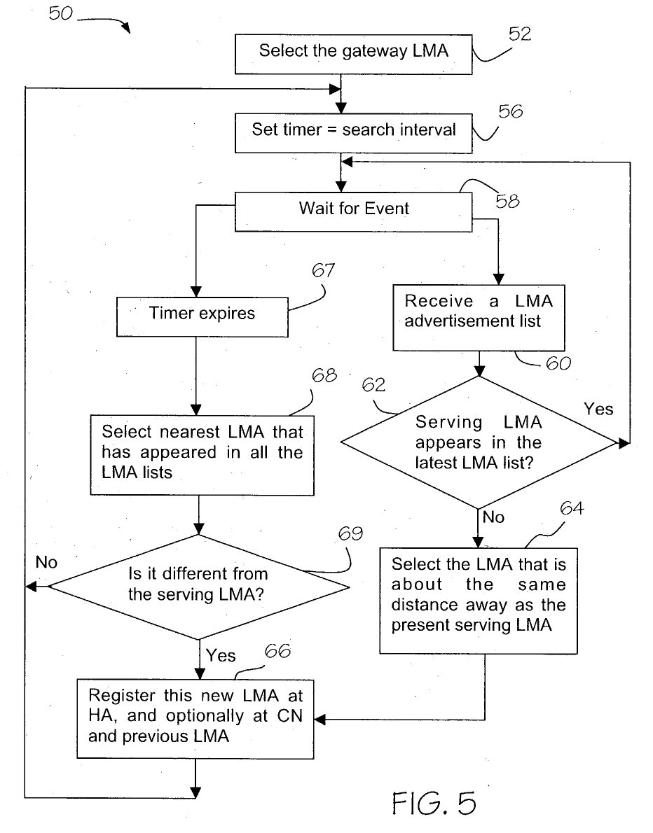

A specific embodiment for selecting a LMA 14 will be described with the aid of FIGS. 3-5. According to this top-down embodiment, the mobility host 12 determines its mobility pattern and selects a LMA 14 based on the mobility pattern for registration with the home agent 32. FIG. 5 shows a selection sequence 50 performed by the mobile host 12 for periodically selecting a LMA 14 for registration. The selection sequence 50 starts in a SELECT GATEWAY LMA step 52 when the mobile host 12 moves into the visited domain 26. In this initial step 52, the mobile host 12 receives a LMA list 54 (FIG. 3) from an access router 40 communicating therewith. The LMA list 54 of an access router 40 includes one or more LMAs 14 on a transmission path of the access router 40 to the home agent 32. From the LMA list 54, the mobile host 12 selects a topmost or furthest LMA 14, in this case a gateway LMA1 in FIG. 3, for registration with the home agent 32 and optionally with any correspondent node 30. The mobile host 12 also registers a local COA with the gateway LMA1. The selection sequence 50 next proceeds to a START TIMER step 56, wherein the mobile host 12 starts or kicks off an internal selection timer, such as a countdown timer initialized with a value denoting a specific time interval. The selection sequence 50 then proceeds to a WAIT FOR EVENT step 58, wherein the mobile host 12 waits either for a selection timer expiry event or an event where the mobile host 12 receives a LMA list 54 from a new access router 40.

The selection sequence 50 proceeds to a RECEIVE LMA LIST step 60 when the mobile host 12 receives a LMA list 54 from a new access router 40. The selection sequence 50 then proceeds to a CURRENTLY REGISTERED LMA IS IN LMA LIST? decision step 62, wherein the mobile host 12 determines if the currently registered LMA 14 appears in the received LMA list 54. If it is determined in this decision step 62 that the currently registered LMA 14 appears in the LMA list 54, no action is taken by the mobile host 12 and the selection sequence 50 returns to the WAIT FOR EVENT step 58 where the mobile host 12 waits for another event to occur. If however, it is determined in the CURRENTLY REGISTERED LMA IS IN LMA LIST? decision step 62 that the currently registered LMA does not appear in the received LMA list 54, the selection sequence 50 proceeds to a FIRST LMA SELECTION step 64. Such will be the case when the mobile host 12 moves out of a coverage area of a currently registered LMA 14. In this step 64, the mobile host 12 selects a LMA from the received LMA list 54, that is a LMA 14 on the transmission path of the new access router 40. Preferably, the mobile host 12 selects a LMA 14 whose distance from the gateway LMA 14A is about the same as the distance of a currently registered LMA from the gateway LMA 14A. Selection of such a LMA takes into account the previous scope of mobility of the mobile host 12. The selection sequence 50 then proceeds to a REGISTER SELECTED LMA step 66, wherein the mobile host 12 registers the selected LMA 14 with the home agent 32 and locally registers its local CoA with the selected LMA 14. The selection sequence 50 then returns to the START TIMER step 56, wherein the mobile host 12 resets the selection timer to delay the expiry of the time interval.

The selection sequence 50 proceeds from the WAIT FOR EVENT step 58 to a TIMER EXPIRY step 67 when the selection timer expires. The selection sequence 50 then proceeds to a SECOND LMA SELECTION step 68, where the mobile host 12 selects a LMA that is common to transmission paths of access routers 40 that have communicated with the mobile host 12 during the preceding time interval as previously described. Thus, a new LMA 14 may be selected depending on the mobility of the mobile host 12 during the time interval. After a common LMA 14 is selected, the selection sequence 50 proceeds to a DIFFERENT LMA SELECTED? step 69, wherein the mobile host 12 determines if the selected LMA is different from the LMA 14 currently registered with the home agent 32. If it is determined that the selected LMA 14 is the same as the one currently registered, the selection sequence 50 returns to the START TIMER step 56. If, however, the selected LMA is different from the one currently registered with the home agent 32, the selection sequence 50 proceeds to the REGISTER SELECTED LMA step 66, where the mobile host 12 registers the selected LMA 14 with the home agent 32 and its local CoA with the selected LMA 14. The selection sequence 50 finally returns to the START TIMER step 56, where the mobile host 12 resets the selection timer to start another time interval for LMA selection. This method therefore allows the mobile host 12 to periodically select an appropriate LMA 14 to serve as its local home agent based on its mobility pattern.

For the mobile host 12 to be able to determine its mobility pattern as described above, each of the access routers 40 communicating with the mobile host 12 is provided with a list 54 of LMAs 14 on its transmission path for forwarding to the mobile host 12 when communicating therewith. Each access router 40 may be provided with a respective list 54 of LMAs 14 by inputting the LMA list 54 on the access router 40 during deployment of the access router 40.

Alternatively, the LMA list 54 may be obtained by allowing each router 56 functioning as a LMA 14 in the visited domain 26 to automatically discover one or more neighboring LMAs 14 so that the LMAs 14 adjacent the access routers 40 may provide the access routers 40 with a LMA list 54 along its respective path to the home agent 32. One method by which a LMA 14 is able to discover its neighboring LMAs 14 is by propagation of an advertisement message through the visited domain 26. The gateway LMA1 initiates propagation of the advertisement message. The single advertisement message is forwarded to neighboring LMAs 14 of the gateway LMA1. Each LMA 14 that receives the advertisement message adds its respective LMA information to the advertisement message to form a new advertisement message. The new advertisement message is in turn forwarded to other LMAs 14. This fanning out of advertisement messages throughout the visited domain 26 results in multiple advertisement messages reaching the LMAs 14 adjacent the access routers 40. From these advertisement messages, the LMAs 14 adjacent the access routers 40 are able to obtain respective list 54 of LMAs for the access routers 40.

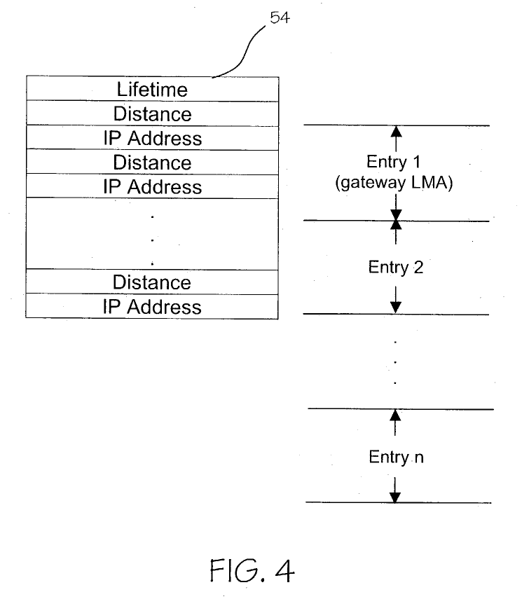

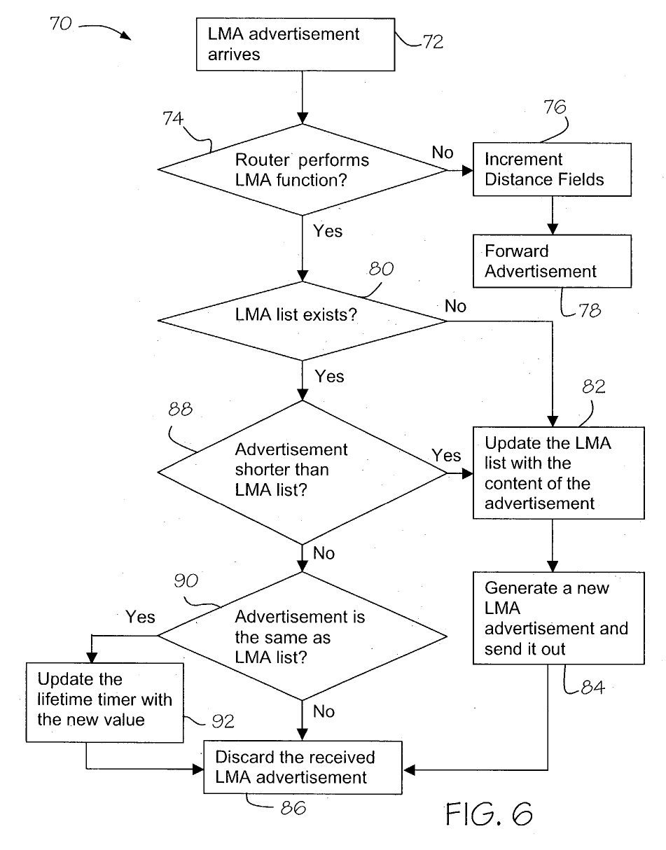

At the gateway LMA1, the advertisement message contains a “lifetime” field and a single LMA entry. The LMA entry includes a “distance” field and an “IP address” field. The “distance” field indicates the distance, in number of hops, from a LMA 14 to the gateway LMA1. In the initial advertisement message, the “distance field” is initialized to the value of one. The “IP Address” field indicates the IP address of a LMA 14. The “lifetime” field indicates the validity duration of a particular LMA 14. An LMA sends an advertisement message periodically so that its neighbors are regularly informed of its availability or reachability. This sending of an advertisement message is independent of a process for processing a received advertisement message that is shown in FIG. 6. FIG. 4 shows the format of an advertisement message propagated by a downstream LMA 14.

FIG. 6 shows a sequence 70 of steps for processing of an advertisement message at a router 56 (FIG. 3) for discovering neighboring LMAs 14. The discovery sequence 70 starts in a RECEIVE ADVERTISEMENT step 72, where the router 56 receives an advertisement message. The discovery sequence 70 proceeds to a PERFORM LMA FUNCTION? step 74, where the router 56 determines if a LMA function is performed by the router 56. If it is determined that the router 56 does not perform the function of a LMA 14, the discovery sequence 70 proceeds to an INCREASE DISTANCE step 76, wherein the router 56 increases the “distance” fields in the advertisement message and forwards the updated advertisement message to its neighboring routers 56 in a FORWARD ADVERTISEMENT step 78. If, however, it is determined in the PERFORM LMA FUNCTION? step 74 that the router 56 performs the function of a LMA, the discovery sequence 70 proceeds to a LMA LIST EXIST? decision step 80. Hereafter, the router 56 that performs the function of an LMA is simply referred to as an LMA 14. In the decision step 80, the LMA 14 determines if a LMA list 54 exists on the LMA 14. If it is determined in this step 80 that no LMA list 54 exists on the LMA 14, the discovery sequence 70 proceeds to an UPDATE LMA LIST step 82, where the LMA 14 creates a LMA list 54 using the information contained in the received advertisement message. The discovery sequence 70 next proceeds to a GENERATE NEW ADVERTISEMENT MESSAGE step 84, where the LMA 14 increases all the “distance” fields in the received advertisement message, appends its own information and sends it out as a new advertisement message. The discovery sequence 70 ends in a DISCARD RECEIVED LMA ADVERTISEMENT step 86, where the LMA 14 discards the received advertisement message.

If, however, it is determined in the LMA LIST EXIST? decision step 80 that a LMA list 54 exists on the LMA 14, the discovery sequence 70 proceeds to a DISTANCE IN ADVERTISEMENT MESSAGE IS SHORTER? decision step 88. In this decision step 88, the LMA 14 compares the distance to the gateway LMA1 recorded in its local LMA list 54 with that in the received advertisement message. If it is determined in this decision step 88 that the distance to the gateway LMA1 in the advertisement message is shorter than that in the LMA list 54, i.e. there exists a shorter path from the LMA 14 to the gateway LMA1, the discovery sequence 70 proceeds to the UPDATE LMA LIST step 82. In the step 82, the LMA list 54 is updated by copying the contents of the received advertisement message into the LMA list 54. The discovery sequence 70 next proceeds to the GENERATE NEW ADVERTISEMENT MESSAGE step 84, wherein the LMA 14 increases all the “distance” fields in the received advertisement message, appends its own information and sends it out as a new advertisement message. The discovery sequence 70 ends in the DISCARD RECEIVED LMA ADVERTISEMENT step 86, where the LMA 14 discards the received advertisement message.

If, however, it is determined in the DISTANCE IN ADVERTISEMENT MESSAGE IS SHORTER? decision step 88 that the distance to the gateway LMA1 recorded in the local LMA list is shorter than that in the received advertisement message, the LMA 14 retains its LMA list 54. The discovery sequence 70 next proceeds to an ADVERTISEMENT MESSAGE SAME AS LMA LIST? decision step 90, wherein the LMA 14 determines if the LMAs 14 in the received advertisement message is the same as that in its LMA list 54. If it is determined in the decision step 90 that the LMAs 14 in the received advertisement message and the LMA 54 are not the same, the discovery sequence 70 proceeds to the DISCARD RECEIVED ADVERTISEMENT MESSAGE step 86, where the LMA 14 discards the received advertisement message.

If, however, it is determined in the ADVERTISEMENT MESSAGE SAME AS LMA LIST? step 90 that the LMAs 14 in the advertisement message and the LMA list 54 are the same, the discovery sequence 70 proceeds to an UPDATE WATCHDOG TIMER step 92, wherein the LMA 14 updates or refreshes a watchdog timer according to the lifetime field in the received advertisement message. The discovery sequence 70 finally ends in the DISCARD RECEIVED ADVERTISEMENT MESSAGE step 86, where the LMA 14 discards the received advertisement message.

When a corresponding advertisement message is absent for a period greater than the time interval set in the watchdog timer, the watchdog timer will expire. This expiry of the watchdog timer indicates that there is a change in router status in the visited domain 26. For example, the LMA 14 that sent the advertisement message earlier may have failed or there may be a link disruption so that the LMA 14 becomes unreachable. The LMAs 14 whose watchdog timer expires will delete its LMA list 54 and start to listen to other LMA advertisement messages to obtain another shortest LMA list 54.

Over time, advertisement messages will propagate the entire visited domain 26 to reach the LMAs 14 adjacent the access routers 40. The number of entries in the advertisement messages will grow as the initial advertisement message gets fanned out throughout the visited domain 26 to reach these LMAs 14. If none of the advertisement messages are lost during propagation, every LMA 14 will be discovered to allow the routers 56 performing the LMA function to build a LMA list 54 that includes LMAs 14 on a shortest path to the gateway LMA1. Although the access router 40 does not perform the function of a LMA 14, each access router 40 is also provided with a LMA list 54 by its adjacent LMA 14. The LMA list 54 at the access router 40 therefore also includes one or more LMAs 14 on a shortest path to the gateway LMA1. The access routers 40 periodically send out their respective list of LMAs, together with router advertisement, to the mobile host 12. In this manner, with each LMA 14 maintaining a list of LMAs, an LMA tree structure is built as shown in FIG. 3.

To perform the above described method of selecting an LMA 14 from multiple LMAs 14 in the generic embodiment, the system 20 includes a subsystem, such as the visited domain 26. The subsystem includes a means for determining a mobility pattern of a mobile host 12 within the visited domain 26 during a given time interval. The subsystem also includes a means for selecting a LMA 14 from the many LMAs 14 at the end of the time interval depending on the mobility pattern and a means for registering the selected LMA 14 with a home agent 32 of mobile host 12 if the selected LMA 14 is different from a LMA 14 currently registered with the home agent 32.

As previously described, the means for determining a mobility pattern includes means for determining at least one LMA 14 along the transmission path of one or more access routers 40 that communicate with the mobile host 12 during the time interval. The means for selecting a LMA 14 includes a means for selecting a LMA 14 common to the transmission path of each of the one or more access routers 40. Preferably, selecting a common LMA 14 includes selecting a common LMA 14 that is closest in distance to the one or more access routers 40.

According to the specific embodiment, a mobile host also includes the above-described means.

Advantageously, the method of selecting a LMA for registration with a home agent as described above allows local registration with a selected LMA to be completed much quicker than a local registration with a gateway LMA since the distance from an access router to a selected LMA may be shorter than the distance to the gateway LMA. Unlike in the prior art where the local registration load is concentrated in a gateway LMA, the method allows the local registration load to be spread amongst several LMAs.

Although the present invention is described as implemented in the above-described embodiment, it is not to be construed to be limited as such. For example, what is described above is a top down approach, wherein a mobile host selects an LMA for registration. Although not as elegant a solution, it is possible that a bottom up approach be taken. In such a bottom up approach, the LMAs along paths of access routers communicating with mobile host during a time interval determine amongst themselves which of the LMAs is to be registered with the home agent.

As another example, the access routers are described to forward the LMA lists to mobile hosts. If the mechanism of link layer handoff notification to an IP layer is present, the mobile host can also request the list of LMAs from an access router without having to wait for an unsolicited message from an access router that carries the LMA list.

We claim:

1. A method of selecting a local mobility agent (LMA) from a plurality of LMAs in a visited domain, to serve as a local home agent, for registration with a home agent in a home domain of a mobile host that has moved into the visited domain, the method comprising:
determining a mobility pattern of the mobile host within the visited domain; and
selecting a LMA from the plurality of LMAs depending on the mobility pattern of the mobile host for registration with the home agent.

2. A method according to claim 1, wherein registration with the home agent is carried out only if the selected LMA is different from a LMA currently registered with the home agent.

3. A method according to claim 2, further including registering the selected LMA with the LMA previously registered with the home agent if the selected LMA is registered with the home agent.

4. A method according to claim 3, further including registering the selected LMA with one or more correspondent nodes communicating with the mobile host if the selected LMA is registered with the home agent.

5. A method according to claim 1, wherein the visited domain includes a plurality of access routers, one or more of which communicate with the mobile host, and wherein determining a mobility pattern and selecting a LMA includes:
determining at least one LMA along a transmission path of one or more access routers that communicate with the mobile host,
wherein the transmission path connects a respective access router to the home agent; and
selecting a LMA common to the transmission path of each of the one or more access routers.

6. A method according to claim 5, wherein selecting a LMA includes selecting a common LMA that is closest in distance to the one or more access routers.

7. A method according to claim 5, further including repeating determining at least one LMA and selecting a common LMA to periodically select a LMA for registration with the home agent.

8. A method according to claim 1, wherein determining a mobility pattern and selecting a LMA are performed by the mobile host.

9. A method according to claim 8, further including:
determining, when a new access router communicates with the mobile host, if the currently registered LMA is on a transmission path of the new access router; and
selecting a LMA on the transmission path of the new access router if the currently registered LMA is determined not to be on the transmission path for registration with the home agent.

10. A method according to claim 9, wherein selecting a LMA on the transmission path includes selecting a LMA on the transmission path whose distance from a gateway LMA is about the same as the distance of the currently registered LMA from the gateway LMA.

11. A method according to claim 8, further including:
providing each access router with a list of LMAs on its respective path for forwarding to the mobile host when communicating therewith.

12. A method according to claim 11, wherein providing each access router with a list of LMAs includes providing each access router with a respective list of LMAs by inputting the list of LMAs on the access router during deployment of each access router.

13. A method according to claim 11, wherein providing each access router with a list of LMAs includes allowing each access router to discover one or more LMAs on its respective path to build the list of LMAs.

14. A method according to claim 13, wherein allowing each access router to discover one or more LMAs includes:
propagating an advertisement message from a gateway LMA along propagation paths towards the access routers, with each LMA along a propagation path adding its respective LMA information to the advertisement message to generate a new advertisement message;
wherein the LMA information includes an IP address of the LMA and a distance of the LMA from the gateway LMA.

15. A method according to claim 14, wherein each LMA maintains a list of LMAs on a shortest path from the LMA to the gateway LMA and generates a new advertisement message only when a received advertisement message includes a shorter path from the LMA to the gateway LMA.

16. A method according to claim 1, further including registering a gateway LMA from amongst the plurality of LMAs with the home agent when the mobile host first moves into the visited domain.

17. A system for mobility management comprising:
a home domain that includes a home agent serving a mobile host; and
a visited domain including:
means for determining a mobility pattern of the mobile host within the visited domain; and
means for selecting a LMA from a plurality of LMAs within the visited domain depending on the mobility pattern for registration with the home agent.

18. A system according to claim 17, wherein registration with the home agent is carried out only if the selected LMA is different from a LMA currently registered with the home agent.

19. A system according to claim 17, wherein the visited domain includes a plurality of access routers, one or more of which communicate with the mobile host, and wherein the means for determining a mobility pattern and the means for selecting a LMA includes:
means for determining at least one LMA along a transmission path of one or more access routers that communicate with the mobile host, wherein the transmission path connects a respective access router to the home agent; and
means for selecting a LMA common to the transmission path of each of the one or more access routers.

20. A system according to claim 19, wherein the means for selecting a LMA includes means for selecting a common LMA that is closest in distance to the one or more access routers.

21. A subsystem that serves as a visited domain for mobility management of a mobile host registered with a home agent in a home domain, the subsystem comprising:
means for determining a mobility pattern of the mobile host within the visited domain;
means for selecting a LMA from a plurality of LMAs in the visited domain depending on the mobility pattern for registration with the home agent.

22. A subsystem according to claim 21, wherein registration with the home agent is carried out only if the selected LMA is different from a LMA currently registered with the home agent.

23. A subsystem according to claim 21, wherein the visited domain includes a plurality of access routers, one or more of which communicates with mobile host depending on movement of the mobile host within the visited domain and wherein the means for determining a mobility pattern and the means for selecting a LMA includes:
means for determining at least one LMA along a transmission path of one or more access routers that communicate with the mobile host, wherein the transmission path connects a respective access router to the home agent; and
means for selecting a LMA common to the transmission path of each of the one or more access routers.

24. A subsystem according to claim 23, wherein the means for selecting a LMA includes means for selecting a common LMA that is closest in distance to the one or more access routers.

25. A mobile host for use in a visited domain having a plurality of LMAs, the mobile host being able to select an LMA from the plurality of LMAs for registration with a home agent in a home domain of the mobile host, the mobile host comprising:
means for determining a mobility pattern of the mobile host within the visited domain;
means for selecting a LMA from the plurality of LMAs depending on the mobility pattern for registration with the home agent.

26. A mobile host according to claim 25, wherein registration with the home agent is carried out only if the selected LMA is different from a LMA currently registered with the home agent.

27. A mobile host according to claim 26, wherein the visited domain includes a plurality of access routers, one or more of which communicate with the mobile host and wherein the means for determining a mobility pattern and the means for selecting a LMA includes:
means for determining at least one LMA along a transmission path of one or more access routers that communicate with the mobile host, wherein the transmission path connects a respective access router to the home agent; and
means for selecting a LMA common to the transmission path of each of the one or more access routers.

28. A mobile host according to claim 27, wherein the means for selecting a LMA includes means for selecting a common LMA that is closest in distance to the one or more access routers.
